(19) United States
(12) Patent Application Publication
(10) Pub. No.: US 2012/0316731 A1
(43) Pub. Date: Dec. 13, 2012

(54) Mini-Spare Yaw Mitigation During Driver Braking

(75) Inventors: Christopher Allen Harrison, Shelby Twp., MI (US); Kurt Myers Branson, Waterford, MI (US); Justin Audley Ruediger, Royal Oak, MI (US)

(73) Assignee: CONTINENTAL AUTOMOTIVE SYSTEMS, INC., Auburn Hills, MI (US)

(21) Appl. No.: 13/158,526

(22) Filed: Jun. 13, 2011

(51) Int. Cl. B60T 8/17; B60T 8/176; B62D 6/00; G06F 19/00; B60T 8/1755

(52) U.S. Cl. 701/41; 701/70; 701/71

(57) ABSTRACT

A method of controlling a brake system comprises monitoring vehicle information with an electronic control unit. An algorithm is performed to detect the presence of a mini-spare tire assembly. A yaw offset value is pre-determined by the electronic control unit when a mini-spare tire assembly is detected at one of the steerable tire assembly locations. The yaw offset is then applied upon detection of a brake event.

### TECHNICAL FIELD

The present disclosure relates to automotive vehicles, and more particularly to braking for automotive vehicles.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Automotive vehicle systems may include control systems to assist the driver in maintaining control of the vehicle during various vehicle functions, such as steering and braking, and under varying vehicle driving conditions. These control systems may take into account many factors including vehicle speed, vehicle acceleration, steering angle, wheel slip, etc. For example, yaw stability control systems use various measurements to determine if the vehicle is experiencing yaw movement and to adjust the vehicle reaction thereby reducing the overall yaw experienced by the driver.

### SUMMARY

A method of controlling a brake system comprises monitoring vehicle information with an electronic control unit. A first steerable tire assembly is detected as being a mini-spare tire. A yaw offset value is then determined by the electronic control unit when the mini-spare tire assembly is detected. The yaw offset is then applied upon detection of a brake event.

A method of controlling a vehicle during braking comprises monitoring vehicle information with an electronic brake system. An algorithm is performed to determine a steerable tire assembly is a mini-spare tire. A dynamic steer recommendation is determined that includes a yaw offset value with the brake system. When a brake event is detected a dynamic steer recommendation including the yaw offset is sent to an electronic power assist steering system.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic top view of a vehicle having a brake system and a spare tire assembly mounted on the vehicle;

FIG. 2 is a schematic diagram of an exemplary system response for a brake system of the prior art;

FIG. 3 is a schematic diagram of an exemplary system response for the brake system of FIG. 1; and

FIG. 4 is a schematic block diagram of an exemplary method of the brake system of FIGS. 1 and 3.

### DETAILED DESCRIPTION

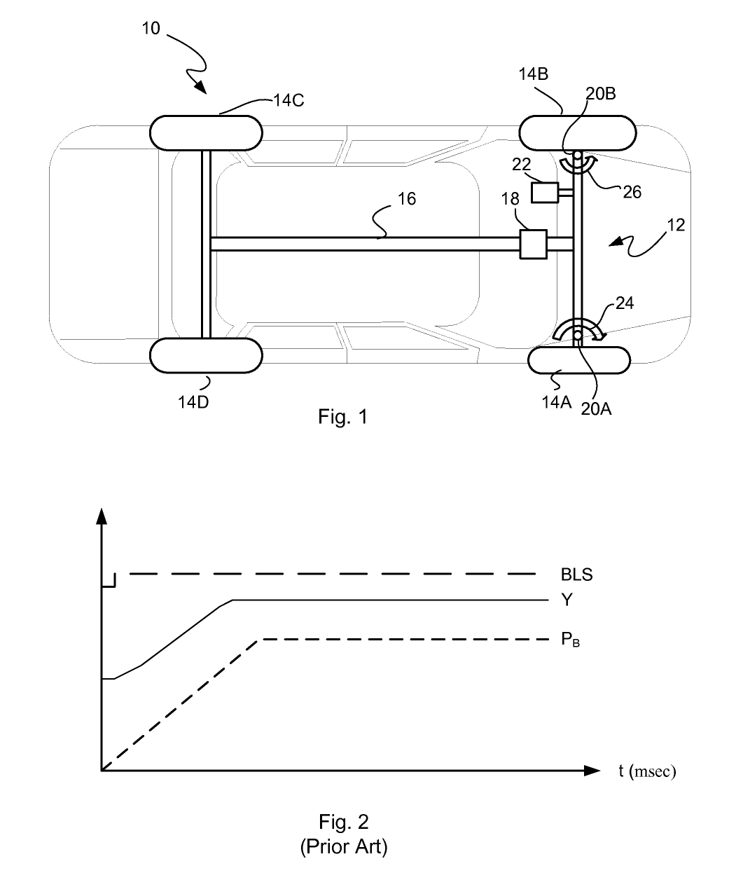

The following description is merely exemplary in nature and is in no way intended to limit the disclosure, its application, or uses. For purposes of clarity, the same reference numbers will be used in the drawings to identify similar elements. FIG. 1 is a schematic illustration of a vehicle 10 having a brake system 12. A plurality of tire assemblies 14A-D are mounted on a drivetrain 16 for the vehicle 10. Each of the tire assemblies 14A-D include a brake assembly (not shown) connected to an ECU 18 for the brake system 12 for braking the associated tire assembly 14A-D and thereby slowing or stopping the vehicle 10. The ECU 18 for the brake system 12 may command multiple features of the brake system 12 including monitoring and analyzing information from the vehicle 10 to provide various functions for the vehicle 10, such as electric stability control (ESC), ABS and other brake system functions.

There are at least first and second steerable tire assemblies 14A, 14B for the vehicle 10. The first steerable tire assembly 14A has a first steering axis 20A and the second steerable tire assembly 14B has a second steering axis 20B. In addition to other functions, the brake system 12 is connected to a steering mechanism 22 which actively adjusts a steering angle of the steering mechanism 22 in order to provide electronic power assist steering (EPAS) for the vehicle 10. The brake system 12 is capable of determining a dynamic steer recommendation (DSR) for the vehicle 10 based upon the vehicle information analyzed by the ECU 18 to assist in controlling the vehicle 10 during stability control actions.

A first tire assembly 14A may be a spare tire assembly, where the circumference, radius, and other features of the first tire assembly 14A may vary when compared to the standard tire assemblies 14B-D mounted at the other wheel mounting locations about the vehicle 10. Often these type of spare tire assemblies are referred to as a mini-spare tire assembly as at least one of the tire dimensions is smaller than the other vehicle tire assemblies 14B-D, in order to reduce the weight and storage space required for the spare tire assembly.

On the vehicle 10 shown, a mini-spare tire assembly is mounted at the location for the first tire assembly 14A. Therefore, at least one of the tire dimensions is smaller than the other vehicle tire assemblies 14B-D. In particular, because of the overall difference in size of the mini-spare tire assembly, the first tire assembly 14A may have a different distance to the steering axis 20A then the distance of the opposing second tire assembly 14B to the steering axis 20B. The different distance between the steering axis 20A and the first tire assembly 14A may result in steer torque on the vehicle 10 when the brakes are applied. In particular, the steer torque may cause yaw (Y) of the vehicle 10, illustrated by arrow 24 in FIG. 1.

FIG. 2 illustrates a response for a typical vehicle and brake system of the prior art when a mini-spare tire is mounted at one of the steerable wheel locations of the vehicle. A brake light switch (BLS) is activated when the brakes are applied. As can be seen by the graphical illustration, as the brake pressure (P_{B}) increases so does the yaw (Y) of the vehicle. Although not shown, the steering wheel angle generally follows the same curve as the yaw of the vehicle. Therefore, if the driver does not actively counter steer, then the vehicle steering wheel turns and the vehicle pulls to one side due to the mini-spare tire assembly.

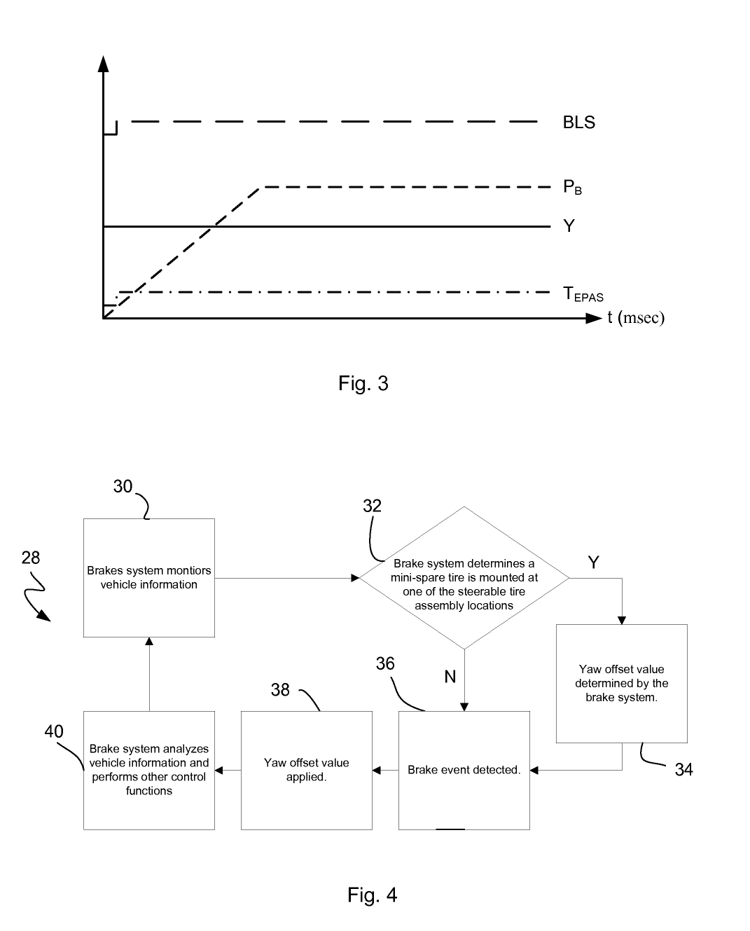

Referring to FIGS. 1 and 3, the vehicle 10 including the brake system 12 mitigates the effects of a mini-spare tire mounted at one of the steerable tire assembly 14A, B locations. In order to compensate the yaw (Y) caused by the mini-spare for the first tire assembly 14A the brake system 12 applies a yaw offset, indicated by arrow 26 in FIG. 1. Although arrow 26 is indicated at the steering axis 20B for the opposing steerable tire assembly 14B, as discussed below, the yaw offset may be applied to a number of locations on the vehicle 10 to offset the steer torque caused by the mini-spare tire.

The brake system 12 may monitor various conditions of the vehicle 10, including but not limited to such factors as, wheel speed of the steerable tire assemblies 14A, 14B and steering angle of the vehicle 10. Based upon the monitored vehicle 10 conditions the ECU 18 for the brake system 12 may perform an algorithm to determine whether one of the tire assemblies 14A-D is a mini-spare tire. The ECU 18 typically utilizes vehicle information gathered from the ESC sensorics. In this instance, the first tire assembly 14A is a mini-spare tire. Upon detection that one of the steerable tire assemblies 14A, B is a mini-spare tire the ECU 18 may provide a yaw offset to the vehicle 10. The yaw offset may be a driver steering recommendation (DSR) to the EPAS and/or a pressure compensation within the brake system 12. The DSR may be a steering angle command or a steering torque command from the brake system 12 to the steering mechanism 22. The compensation by the brake system 12 may be a decrease in brake fluid pressure at the wheel location to which the mini-spare tire assembly is mounted, in this case the first tire assembly 14A. The brake system 12 may alternatively or also include an increase in brake fluid pressure at the opposing steerable tire assembly location, in this instance the second tire assembly 14B.

The brake system 12 proactively detects the mini-spare tire assembly and determines the yaw offset prior to a braking event. As a result of including the yaw offset proactively, as soon as a brake event of the vehicle 10 is detected the yaw offset is applied by the brake system 12 to the EPAS and/or at the appropriate tire assembly 14A-D. A brake event may be detected by activation of a brake light switch, by a master cylinder pressure sensor, or by an actuation travel sensor. The yaw offset is, an active command by the braking system 12 rather than a reactive response by the brake system 12 that is initiated only after a yaw of the vehicle 10 has been detected. That is, the determination to apply the yaw offset and the value of the offset is determined prior to a brake event and actively applied immediately when a brake event is detected.

By actively providing the yaw offset by the brake system 12 the overall yaw (Y) seen by the vehicle 10 is mitigated. Therefore, the yaw (Y) does not increase as the brake pressure is increased. The constant EPAS torque of FIG. 3 represents the yaw offset applied to the vehicle 10. As a result, the counter-steer required by the driver to steer the vehicle in a straight line may be reduced or completely eliminated. As shown in FIG. 3, which illustrates the same operating conditions as compared with the prior art brake system shown in FIG. 2, the overall yaw (Y) experienced by the vehicle 10 does not increase.

Further functions performed by the brake system 12, such as electronic stability control (ESC), or yaw stability control (YSC) that reactively assist in controlling the vehicle 10 may incorporate the applied yaw offset 26 of the brake system 12.

FIG. 4 illustrates a method 28 of the brake system 12 for applying the yaw offset 26 to the vehicle 10. The brake system 12, in particular the ECU 18, monitors information from the vehicle 10, step 30. The information from the vehicle 10 may include data such as wheel speed and steering angle. Based upon the information from the vehicle 10 the brake system 12 performs an algorithm that determines whether a mini-spare tire assembly has replaced one of the steerable tire assemblies 14A, 14B for the vehicle 10, step 32. The brake system 12 utilizes the ESC sensoric information to determine whether there is a mini-spare tire assembly. When the mini-spare tire assembly is detected the brake system 12 determines a yaw offset 26, step 34. When a brake event is detected, step 36, the yaw offset 26 is applied to the vehicle 10, step 38. The yaw offset 26 may be applied by providing a DSR to the EPAS and/or by compensating the pressure at one or more of the vehicle tire assemblies 14A-D with the brake system 12.

If no yaw offset has been entered in the system, the yaw offset value is zero. The brake system 12 may continue to further reactively analyze the vehicle data and perform other control functions as necessary, step 40. The brake system 12 routinely monitors the information from the vehicle 10, step 30, and continues to apply the yaw offset 26 during braking as long as the mini-spare tire assembly is detected for one of the steerable tire assemblies 14A, 14B. If the brake system 12 does not determine that one of the steerable tire assemblies 14A, 14B is a mini-spare tire then a yaw offset value of zero is applied, step 38, and the brake system 12 continues to provide other functions, step 40.

While the best modes for carrying out the invention have been described in detail the true scope of the disclosure should not be so limited, since those familiar with the art to which this invention relates will recognize various alternative designs and embodiments for practicing the invention within the scope of the appended claims.

What is claimed is:

1. A method of controlling a brake system comprising:
monitoring vehicle information with an electronic control unit;
determining a first steerable tire assembly is a mini-spare tire;
determining a yaw offset with the electronic control unit when the first steerable tire assembly is a mini-spare tire;
detecting a brake event; and
applying the yaw offset upon the detection of a brake event.

2. The method of claim 1, wherein the determining a first steerable tire assembly is a mini-spare tire further includes utilizing the stability control system sensoric information.

3. The method of claim 1, wherein the monitoring the vehicle information further includes monitoring at least one of a wheel speed for each of the steerable wheels for the vehicle and a steering angle of the vehicle.

4. The method of claim 1, further comprising:
the brake system performing at least one of electronic stability control, yaw stability control and anti-lock brake control after applying the yaw offset.

5. The method of claim 1, wherein detection of a brake event occurs when one of: a brake light sensor is activated, a master cylinder pressure sensor is activated and an actuation travel sensor.

6. The method of claim 1, wherein applying the yaw offset further includes providing the vehicle with at least one of: a steering angle command, a steering torque command, and a pressure adjustment of the braking pressure for at least one of the tire assemblies.

7. A method of controlling a vehicle during braking comprising:
monitoring vehicle information with an electronic brake system;
performing an algorithm to determine a steerable tire assembly is a mini-spare tire;
determining a dynamic steer recommendation including a yaw offset value with the brake system;
detecting a brake event; and
sending the dynamic steer recommendation including the yaw offset to an electronic power assist steering system upon detection of a brake event.

8. The method of claim 7, wherein the determining a first steerable tire assembly is a mini-spare tire further includes utilizing the stability control system sensoric information.

9. The method of claim 7, wherein the monitoring of the vehicle information further includes monitoring at least one of: a wheel speed for each of the steerable wheels for the vehicle, and a steering angle of the vehicle.

10. The method of claim 7, further comprising:
the electronic brake system performing at least one of electronic stability control, yaw stability control and anti-lock brake control after applying the dynamic steer recommendation including the yaw offset.

11. The method of claim 7, wherein detection of a brake event occurs when one of: a brake light sensor is activated, a master cylinder pressure sensor is activated and an actuation travel sensor.

12. The method of claim 7, wherein sending the dynamic steer recommendation further includes providing the electronic power assist steering with one of: a steering angle command and a steering torque command.

13. The method of claim 7, further comprising:
providing the vehicle with a pressure adjustment of the braking pressure for at least one of the tire assemblies in addition to the dynamic steer recommendation.
